(19) United States
(12) Patent Application Publication
(10) Pub. No.: US 2006/0146781 A1
(43) Pub. Date: Jul. 6, 2006

(54) Acess to cellular services from an internet protocol network

(75) Inventors: Farid Adrangi, Lake Oswego, OR (US); Kaustubh Das, Hillsboro, OR (US); Prakash Iyer, Beaverton, OR (US)

Correspondence Address: VENABLE LLP, P.O. BOX 34385, WASHINGTON, DC, 20045-9998, US

(73) Assignee: Intel Corporation, Santa Clara, CA (US)

(21) Appl. No.: 11/024,987

(22) Filed: Dec. 30, 2004

(51) Int. Cl. H04J 3/24; H04L 12/54

(52) U.S. Cl. 370/349; 370/428

(57) ABSTRACT

Access to 3^{rd} generation cellular services may be provided for a mobile Internet Protocol (IP) client which may be connected via a wireless local area network (WLAN) by maintaining in a home agent a plurality of IP addresses assigned to the MIP client.

### BACKGROUND OF THE INVENTION

Wireless local area network (WLAN) access networks (AN) are being deployed in public places such as, e.g., but not limited to, airports, hotels, shopping malls, and coffee shops. WLAN access points (APs), commonly referred to as, e.g., “hotspots” provide low cost public access to data services, but are generally used indoors have only a minimal range intended for local area network (LAN) applications. Third (3^{rd}) generation (3G) wireless networks provide broader coverage for 3G users than do WLAN networks. The cost advantage of WLAN networks make WLAN access desirable to 3G users when available. Thus interworking between WLAN and 3G networks is useful. A WLAN AN may have direct or indirect roaming agreements with one or more 3G home operator networks to enable 3^{rd} generation partnership project (3GPP) network users connected to the WLAN AN to access services provided by the home operator networks of the 3GPP users. Conventionally 3G operators control access to 3G services through a mechanism that allocates a different Internet Protocol (IP) address, i.e., a packet data protocol (PDP) context, for each different class of service. Meanwhile, conventional user equipment (UE) devices running conventional operating systems do not assign multiple IP addresses to a single network card instance, but rather assign only a single IP address for every connected network card. Lack of support for assigning more than one IP address to a single IP client leads to a situation where 3G operator services are conventionally inaccessible to a user through a WLAN access point (AP).

### BRIEF DESCRIPTION OF THE DRAWINGS

Various exemplary features and advantages of the invention will be apparent from the following, more particular description of exemplary embodiments of the present invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary wireless local area network and cellular network interworking environment depicting an exemplary mobile node which may be roaming between hotspots or subnets within a hotspot, while it may be accessing exemplary operator services according to an exemplary embodiment of the present invention;

FIG. 2 depicts an exemplary embodiment of a diagram illustrating an exemplary control signaling between network components which may enable a mobile node to access an operator provided service, according to an exemplary embodiment of the present invention;

FIG. 3 depicts an exemplary embodiment of a home agent binding table and pending tables for the home agent and a mobile node according to an exemplary embodiment of the present invention;

FIG. 4 depicts an exemplary embodiment of packet formats for internet protocol (IP) data packets as data may be communicated from the mobile node to a 3G server which may be accessed according to an exemplary embodiment of the present invention; and

FIG. 5 depicts an exemplary embodiment of a computer system that may be used in the target or source devices according to an exemplary embodiment of the present invention.

### DETAILED DESCRIPTION OF EXEMPLARY EMBODIMENTS OF THE PRESENT INVENTION

Exemplary embodiments of the invention are discussed in detail below. While specific exemplary embodiments are discussed, it should be understood that this is done for illustration purposes only. A person skilled in the relevant art will recognize that other components and configurations may be used without parting from the spirit and scope of the invention.

TABLE 1

| Acronym | Definition |
|---|---|
| 3G | Third-generation mobile telephony protocols support higher |
| | data rates than 1G and 2G, and are intended for applications |
| | in addition to voice, such as, but not limited to, full-motion |
| | video, video-conferencing and full Internet access. |
| GPRS | General Packet Radio Service |
| HA | Home Agent |
| SGSN | Service GPRS Support Node |
| GGSN | Gateway GPRS Support Node |
| FA | Foreign Agent |
| MN | Mobile Node |
| PDN | Packet Data Network |
| PLMN | public land mobile network |
| IPv4 | IP version 4 |
| WLAN AN | Wireless Local Area Network Access Network |
| WLAN AP | Wireless Local Area Network Access Point |
| WLAN UE | Wireless Local Area Network User Equipment |

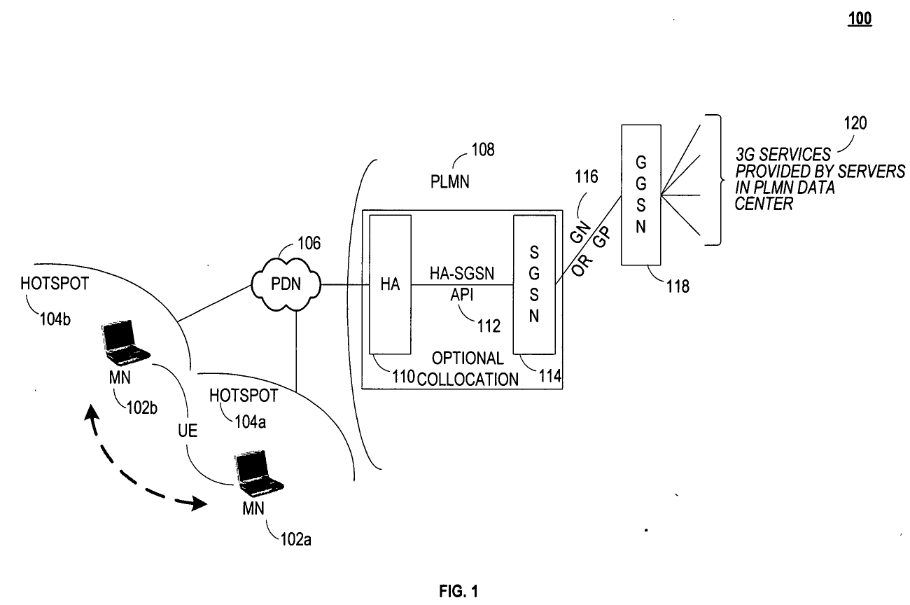

FIG. 1 depicts an exemplary network environment 100 illustrating an exemplary embodiment of a wireless local area network (WLAN) that may be coupled to a 3^{rd} generation (3G) cellular wireless network according to an exemplary embodiment of the present invention. The WLAN access network (AN) may include one or more WLAN user equipment (UE) mobile nodes (MNs) 102a, 102b (collectively 102) that may access the WLAN network via one or more hotspots 104a, 104b (collectively 104). MN 102 may be permitted to roam between hotspots 104b and 104a, or between subnets within a hotspot, as indicated by the dotted arrow lines. The hotspots 104 may be coupled in turn to a packet data network 106. Hotspots 104 may operate via one of various well known protocols such as, e.g., but not limited to, wireless LANs compliant with IEEE std. 802.11a, b, d or g, such as, e.g., but not limited to, IEEE std. 802.11 a, b, d and g, (including, e.g., IEEE Std 802.11, 1999 Edition; or IEEE Std 802.11a-1999, IEEE Std 802.11b-1999, IEEE Std 802.11b-1999/Cor 1-2001, IEEE Std 802.11d-2001, IEEE Std 802.11-1999 (R2003), and/or IEEE 802.11g-2003, etc.). FIG. I further illustrates, in an exemplary embodiment, the PDN 106 may be coupled to a public land mobile network 108 as shown, via, e.g., but not limited to, a home agent 110, which may in turn be in communication with a service general packet radio service (GPRS) support node (SGSN) 114 via, e.g., but not limited to, an HA-SGSN application programming interface (API) 112. In an exemplary embodiment, the HA 110 and SGSN 114 may be collocated, however they need not be collocated. As illustrated in the exemplary embodiment of diagram 100, SGSN 114 may be in communication with a gateway GPRS support node (GGSN) 118 over a communications link 116 which, in an exemplary embodiment, may include a Gn interface (GN) or a Gp interface (GP) communications link 116. GGSN 118 may be used to provide access to one or more 3G operator services 120 that may be provided via one or more servers that may be in a data center associated with PLMN 108.

In an exemplary embodiment, communication between the WLAN and 3G networks may comply with any of a number of relevant standards. One exemplary architecture of an exemplary WLAN-3GPP interworking may be specified by, e.g., but not limited to, 3GPP Technical Specification Group Services and System Aspects; 3GPP system to Wireless Local Area Network (WLAN) Interworking; System Description (Release 6), 3GPP TS 23.234 V2.4.0(2004-01), of the 3GPP SA2 working group, etc. Yet another is the TR 22.934 of the 3GPP SA1 working group.

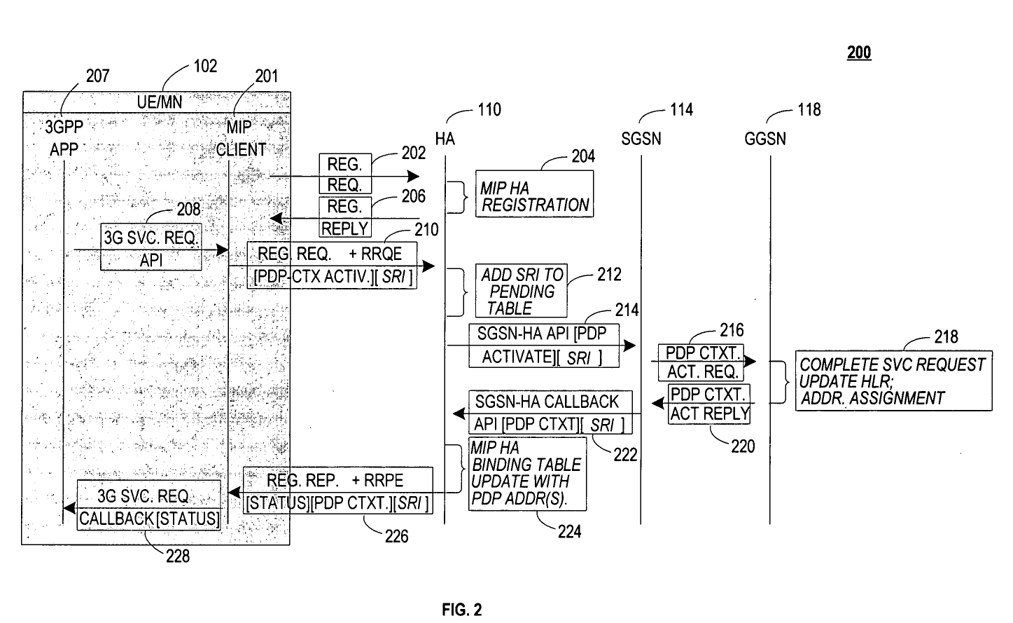

The present invention may enable mobile node 102 clients to use a single IP address (such as, but not limited to, an IPv4 or IPv6 address) while accessing 3G services 120, where each of the 3G services 120 may be associated with different PDP IP addresses. 3G applications 207 (discussed further below with reference to FIG. 2) that may be running on the MN 102 client devices, may still need to issue a PDP context activation in order to access the services provided by the Home Service Network (HSN) of the user, but the MN 102 clients do not need to know or maintain the assigned PDP IP addresses. The handling of the PDP IP addresses may be achieved, according to an exemplary embodiment of the present invention, by introducing an enhanced Mobile IP (MIP) Home Agent (HA) 110 component in the HSN and by installing an enhanced MIP-enabled client software application 201 (discussed below with reference to FIG. 2) on the MN 102 client devices (hereafter, also referred to as MIP-enabled client 201). Each MIP-enabled client 201 may be associated with two IP addresses: a MIP home address (i.e., an invariant IP address assigned by the HA 110) and a care-of address (assigned by the respective foreign network).

Mobile IP nodes may comply with any of a number of relevant standards, including, e.g., but not limited to, Request For Comments (RFC) 3344, IP Mobility Support for IPv4, Network Working Group, version August 2002, etc.

Enhanced HA 110, in accordance with an exemplary embodiment of the present invention, may maintain one or more PDP IP addresses assigned to the MIP-enabled client 201 by the GGSN 118 (as a result of one or more PDP context activations issued by the MIP-enabled client 201) in a binding table of the HA 110. According to the present invention, all applications running on the MIP-enabled client 201 MN 102, may bind to a single IP address (i.e., the MIP home address). Upon the receipt of an IP packet from a MIP-enabled client 201 MN 102, the HA 110 may replace the source IP address of the IP packet with the appropriate PDP IP address based on the destination IP address of the IP packet, and then may forward the packet on to the SGSN 114. When the HA 110 receives an inbound IP packet from a 3GPP server (such an IP packet originating at a 3G server and destined for a client may be referred to herein as an “inbound IP packet”, whereas an IP packet originating from a client, destined for a 3G server may be referred to as an “outbound IP packet”), via the SGSN 114, from GGSN 118, where the IP packet is destined to an MIP-enabled client 201 MN 102 of the HA 110, the HA 110 may in accordance with an exemplary embodiment of the present invention replace the destination IP address of the inbound IP packet with the home address of the MIP-enabled client 201 MN 102, and may then forward the inbound IP packet on to the MIP-enabled client 201 MN 102.

Enhanced MIP-enabled client 201 software of MN 102, in accordance with an exemplary embodiment of the present invention, may implement an API that may be called by 3G applications to make a service request through a PDP-context activation request. Upon receipt of a service request from a 3G application through the API, the MIP-enabled client software 201 may create a new registration request message to relay a PDP context activation/deactivation request to the HA 110, which may include a registration request extension (RRQE) (as discussed further with reference to reference numeral 210 in FIG. 2, below). The RRQE may convey, e.g., but not limited to, at least two items: 1) the PDP-context activation/deactivation request; and 2) a service request identifier (SRI) generated by the MIP client software 201 of MN 102. The MIP-enabled client software 201 may bind each entry in a registration pending table of HA 110 with the appropriate SRI in order to call the appropriate callback API upon receipt of a registration reply containing a PDP-context activation/deactivation reply (as discussed further with reference to reference numeral 226, in FIG. 2, below).

Enhanced 3G applications, in accordance with an exemplary embodiment of the present invention, may call the MIP-enabled client software 201 API to make service requests, and the 3G applications may also implement a callback API that may be called by the MIP-enabled client 201 software to inform the result of a service request.

FIG. 1 initially described above with reference to network environment 100 may include various enhanced versions of conventionally existing MIP and 3G components. Exemplary enhancements may include the following features that may be provided to 3G applications, mobile IP client, mobile IP home agent, and the SGSN, as discussed further below.

3G Applications

The 3G applications, in accordance with an exemplary embodiment of the present invention, may implement a callback API that may call a mobile IP (MIP) client 201 user-mode software that may pass a result of a PDP context activation/deactivation request. The callback API may include, e.g., but not limited to, at least two parameters: 1) a PDP context activation/deactivation reply; and 2) a Success/Failure status.

On startup, the 3G application may call into the MIP client 201 to initiate a service request, as illustrated by reference numeral 208 in FIG. 2.

Mobile IP Client

The MIP client 201 user-mode software may implement the service request (SR) API as illustrated by reference numeral 208 in FIG. 2, that may be called by 3G applications running on the client device to issue PDP context activation/deactivation requests. The SR API may include, e.g., but not limited to, at least two parameters: 1) a PDP context activation/deactivation request; and 2) a 3G Application callback API address.

Upon invocation of the 3G SR API, the Mobile IP client 201 user-mode software may, as illustrated by reference numeral 210 in FIG. 2, create a new registration request message to relay a PDP context activation/deactivation request to the HA 110 via an RRQE. The RRQE may include, e.g., but is not limited to, at least two items: 1) a PDP-context activation/deactivation request; and 2) a service request identifier (SRI) generated by the MIP client user-mode software.

MIP client 201 user-mode software may bind each entry in a registration pending table of the MIP client 201 with the appropriate service request identifier (SRI).

The MIP client 201 user-mode software may be able to process the registration reply for a PDP context activation/deactivation request and may call the appropriate callback API implemented by the 3G applications. The RRPE, as illustrated in reference numeral 226 of FIG. 2, may include, e.g., but is not limited to, at least three items: 1) PDP-context activation/deactivation reply; 2) a SRI; and 3) a Success/Failure status.

Mobile IP Home Agent

In an exemplary embodiment of the invention, the home agent 110 may require deployment of an enhanced Mobile IP Home Agent (HA) 110 in the operator network. For example, a MIP HA compliant with standard RFC 3344, August 2002 (discussed above), etc. may be used. The HA, in an exemplary embodiment, may include, e.g., but is not limited to, the following described features.

The HA 110 of FIG. 1, in an exemplary embodiment, as illustrated in 210 of FIG. 2, may be able to process a new registration request extension (RRQE) containing, e.g., but not limited to, a PDP context activation/deactivation request; and a service request identifier (SRI) that may identify the calling 3G Application.

The HA 110, as illustrated in 212 of FIG. 2, may be able to bind each entry in a registration pending table of the HA 110 to an SRI (that may be received in RRQE).

The HA 110 may, in an exemplary embodiment, be able to create an IP packet containing the PDP context activation/deactivation request (received in the RRQE) and may send the PDP context activation/deactivation request to the SGSN, e.g., but not limited to, through layer 2 or 3 encapsulation, or, e.g., but not limited to, an appropriate API implemented by the SGSN 114, if, e.g., but not limited to the case where, HA 110 and SGSN 114 are combined in another exemplary embodiment.

The HA 110 may, in an exemplary embodiment, implement a callback API that may be called by the SGSN 114 to pass the result of PDP context activation/deactivation to the HA 110, as illustrated by 222 in FIG. 2. The callback API may convey, e.g., but is not limited to, at least four parameters to the HA 110: 1) PDP context activation/deactivation reply; 2) the SRI; 3) PDP context IP address; and 4) Success/Failure status.

On receiving a reply for a PDP-context activation/deactivation request from the SGSN 114 through the callback API, the HA 110 may, in an exemplary embodiment, be able to update the appropriate entry in a binding table of the HA 110, with the received PDP context IP address, and may create a registration reply (RRP) with a new extension that may contain, e.g., but is not limited to, at least 3 parameters: 1) PDP context activation/deactivation reply; 2) the SRI; and 3) Success/Failure status.

For a given registered MIP client 201, the HA 110 may be able to bind one or more PDP context IP addresses to an entry in a binding table of the HA 110.

On receiving a MIP encapsulated data packet from a client, the HA 110 may be able to remove the outer IP header (as specified in RFC 3344), may map the source IP address of the inner IP packet to the corresponding PDP context IP address stored in the binding entry, and may forward the IP packet to the SGSN 114, using, e.g., but not limited to, a layer-2 forwarding mechanism, or inside a tunnel established between the HA 110 and SGSN 114.

The HA 110, in an exemplary embodiment, may enforce reverse tunneling for Mobile IPv4.

SGSN

In an exemplary embodiment of the present invention, the SGSN 114 may implement an SGSN-HA API, as illustrated by reference numeral 214 in FIG. 2, that may be called by the HA 110 to pass PDP context activation/deactivation requests from the MIP client 201 to the SGSN 114. The SGSN-HA API may convey, e.g., but is not limited to, at least three parameters to the SGSN: 1) PDP context activation/deactivation request; 2) the SRI; and 3) HA callback API address.

On receiving a reply, as illustrated by 220 of FIG. 2, for a PDP context activation/deactivation request, the SGSN 114, may invoke the callback API, as illustrated by reference numeral 222 of FIG. 2, implemented by the HA 110 to pass the reply for a PDP context activation/deactivation request to the HA 110.

The SGSN 114, in an exemplary embodiment, may maintain a table (referred to as Hotspot UE table) of PDP addresses that are being serviced by the HA 110. Whenever the SGSN 114 terminates a GPRS tunneling protocol (GTP) tunnel for a data packet that is destined to an address in the Hotspot UE table, the SGSN 114 may send the data packet to the HA 110. The packet may be sent via, e.g., but not limited to, a layer-2 forwarding interface, or through a tunnel established between the HA 110 and the SGSN 114, for this purpose.

Control Packet Flow

FIG. 2 depicts a diagram 200, illustrating, in an exemplary embodiment of the present invention, control signaling to enable a MN 102 to access an operator provided 3G service. Diagram 200 illustrates exemplary control and data packet flow between a 3GPP application 207, MIP Client 201, HA 110, SGSN 114, and GGSN 118. All discussions of control signaling with reference to FIG. 2, are with reference to the system architecture diagram 100 as discussed above with reference to FIG. 1.

FIG. 2 shows, in an exemplary embodiment, control flow that may enable the MN 102 within Hotspot 104 of FIG. 1 to be able to access a cellular operator 3G service. Modifications to conventional signaling have been described above, with reference to enhancements to the components of FIG. 1.

Referring to FIG. 2, when a Mobile IP Node (MN) 102 connects to an 802.11 based wireless network (hereafter, referred to as a hotspot 104), MN 102 may acquire a care-of address and may initiate a Registration Request (RRQ) 202 to a HA 110 of MN 102, as specified in RFC 3344, discussed above, etc. Upon the successful registration 204, the MN 102 from registration reply 206 may have a home address, and all running applications on the MN 102 may bind to that home address. When a user (not depicted) desires to access services provided by a 3G operator of the user, the user may launch an appropriate 3G-based application 207, which may initiate a series of signals.

In 208, 3G application 207 may call a service request (SR) API, implemented by the MIP client 201 user-mode software, to issue a PDP context activation/deactivation request.

In 210, the MIP client 201 user-mode software may generate a unique SRI for this request, may create a RRQ containing a new RRQE (as defined above), may create a new entry in a registration pending table of MN 102 and may associate the new entry with the SRI and a 3G application callback API address, and may send the RRQ to the HA 110.

In 212, when the HA 110 receives the RRQ with the new RRQE, the HA 110 may create a new entry in a registration pending table of the HA 110 (if a registration pending table entry does not already exist).

In 212, the HA 110 may associate the new entry with the SRI received in the RRQE of 210.

In 214, the HA 110 may call an API implemented by the SGSN 114 (hereafter, referred to as SGSN-HA API) that may relay the PDP context activation/deactivation request, the SRI, and the HA callback API address to the SGSN 114.

In 216, the SGSN 114 may create a new PDP context activation/deactivation request, as defined in the 3GPP specification, and may send the PDP context activation request to the GGSN 118. The SGSN 114 may also associate each pending PDP context activation/deactivation request with the SRI and the HA callback API address received through the SGSN-HA API.

In 218, the GGSN 118 may process the request, completing the service request, updating a home location register (HLR), and creating an address assignment.

In 220, the GGSN 118 may send the PDP context activation/deactivation reply to the SGSN 114.

In 222, the SGSN 114 may call a SGSN-HA callback API, that may pass the PDP context activation/deactivation reply, the SRI, the PDP context IP address, and the request status to the HA 110.

In 224, the MIP HA 110 binding table may be updated with the PDP address(es).

In 226, the HA 110 may create an appropriate registration reply (corresponding to the appropriate pending RRQ-this may be determined by the SRI) containing the new RRPE (specified above), and may send the RRP to the MIP client 201.

In 228, when MIP client 201 user-mode software receives a RRP with the new RRPE, the MIP client 201 may extract the information from the RRPE, may determine the 3G application callback API address from its pending RRQ using the SRI, and may call the callback API to pass the PDP context activation/deactivation reply to the 3G application 207.

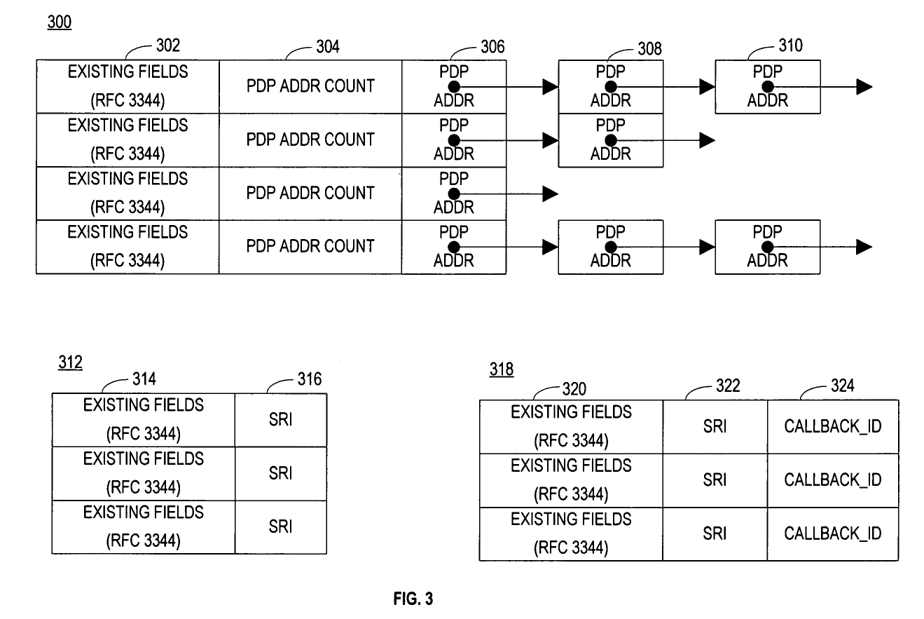

FIG. 3 depicts an exemplary embodiment of a binding table 300 and pending tables 312 and 318, as may be used in accordance with an exemplary embodiment of the present invention. Binding table 300, in an exemplary embodiment, may include records including, e.g., but not limited to, existing fields 302 dictated by RFC 3344, a PDP address count field 304, a PDP address field 306, mapped to PDP address field 308, and PDP address field 310, as appropriate. Pending table 312, in an exemplary embodiment, may be associated with HA 110, and may include, e.g., but is not limited to, existing fields 314 dictated by RFC 3344, and service request identifier (SRI) field 316. Pending table 318, in an exemplary embodiment, may be associated with MN 102, and may include, e.g., but is not limited to, existing fields 320 dictated by RFC 3344, service request identifier (SRI) field 322, and callback_id field 324.

Data Packet Flow

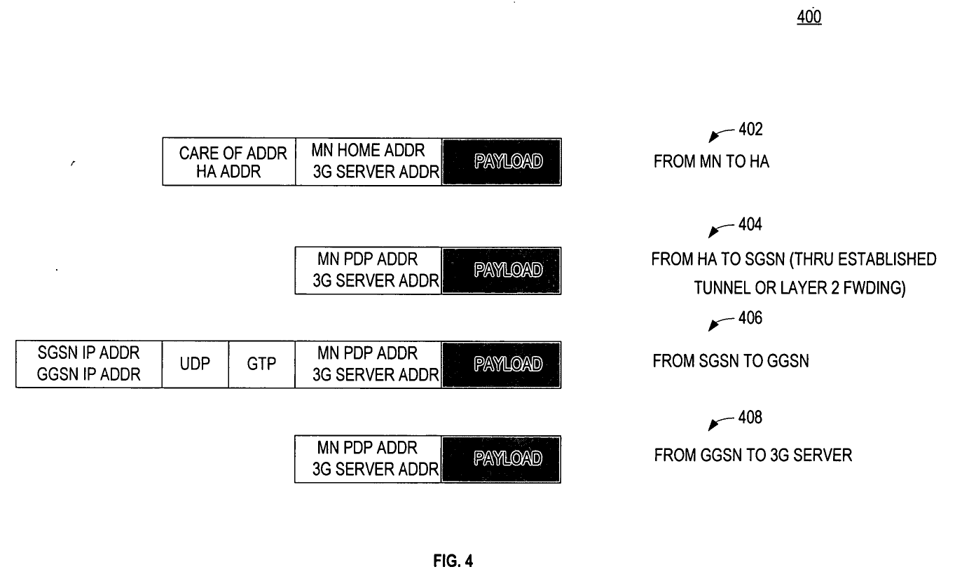

FIG. 4 depicts a diagram 400, illustrating, in an exemplary embodiment of the present invention, exemplary data packet flow from a MN 102 to a server that may provide access to a 3G service, and vice versa. Specifically, FIG. 4 illustrates various exemplary embodiments of packet formats that may be used for IP data as the IP data may be transmitted to and from between MN 102 and the 3G service 120 server that may be being accessed.

As shown in diagram 400 of FIG. 4, on the way down the protocol stack, the transmission control protocol/Internet Protocol (TCP/IP) layers on the MN 102 may create an IP packet bound to a destination address associated with the PLMN 108 server whose service may be being accessed. In 402, the IP packet may be encapsulated by the MIP data layer and may be sent to the HA 110 (this may be referred to as reverse tunneling). In 404, when the HA 110 receives the encapsulated data packet, the HA 110 may remove the outer IP header, may replace the source IP address of the inner packet with the corresponding PDP context IP address (which may be obtained from a binding table 300 of the HA 110 based on the destination IP address of the inner IP packet), may update the appropriate IP header fields, and may forward the packet to the SGSN 114. The forwarding between HA 110 and SGSN 114 may be done through, e.g., but not limited to, a layer-2 forwarding, or through a tunnel established between the HA 110 and SGSN 114 in an a priori manner. It is also important to note that in another exemplary embodiment SGSN 114 and HA 110 may also be provided. In 406, the SGSN 114 may send the received packet to the GGSN 118 through, e.g., but not limited to, a GPRS tunnel protocol (GTP) tunnel-i.e., the GGSN 118 may add appropriate IP/UDP/GTP headers to the received packet and may send it to the GGSN 118. In 408, the GGSN 118 may strip off the GTP header and may treat the packet as the GGSN 118 might any other data packet in the PLMN 108 and may forward the packet to the server providing the 3G service 120.

On the way up from the server to the MN, when the SGSN receives GTP tunneled packets from the GGSN, it may first (de)capsulate the packet. Then, it may determine whether it should forward the packet to the HA (or not) based on its source IP address (i.e., PDP context IP address). When the HA receives the packet, it may replace its source IP address with the appropriate MN home address (which may be obtained from its enhanced registration binding table), may apply MIP forward encapsulation, and may send it to the MN.

In an exemplary embodiment of the present invention, the solution may be based on open IP protocols for WLAN based access to cellular core services.

An exemplary embodiment of the present invention may not introduce a new protocol. The exemplary embodiment, may piggy back on the Mobile IP standard. In the exemplary embodiment, no operator protocols may be mandated on the client device MN 102. At the same time, the exemplary embodiment of the present invention may ensure that the operator's core network is not impacted. No changes to the GGSN 118 may be necessary. The GGSN 118 may be the main anchor router in the PLMN 108. No changes may be required of SGSNs 114 in the PLMN 108 other than those that may be made to the SGSN 114 that may be facilitating hotspot 104 access in concert with the HA 110, according to an exemplary embodiment of the present invention.

The exemplary embodiment of the present invention may be symmetrical for access irrespective of whether the hotspot 104 is owned by a home or a visitor PLMN 108.

The exemplary embodiment of the present invention may allow for service authorization on a per service granularity. Already authorized services may continue to be running while a new service may be requested and authorized (or, for that matter, deauthorized).

The exemplary embodiment of the present invention may not require any modifications or enhancements to network stack architecture or the driver model of the client device MN 102.

The exemplary embodiment of the present invention may make use of services provided by 3G operators transparent to IP-based client devices and the applications of the client devices.

The exemplary embodiment of the present invention may provide IP mobility where users may move from one WLAN network such as, but not limited to, an 802.11 based wireless network, to another, while accessing different 3G services where each of the different 3G services may be associated with a different PDP context.

The present invention may provide service access forconventional client devices and OSs by allowing a client to bind a single network interface card (NIC) card to multiple addresses.

Moreover, in an exemplary embodiment, GPRS routing mobility mechanisms may be preserved and may be used to a furthest extent, and may introduce no routing and data overhead within a GPRS network.

An exemplary embodiment of the present invention may require no changes to GGSN 118 and deployed SGSNs 114 (except the SGSN 114 that in conjunction with the HA 110 may enable the access).

The exemplary embodiment of the present invention may be deployed in stages, i.e., not all PLMNs 109 may need to introduce a new MIP-enabled HA 110/SGSN 114 entity-instead, the MIP-enabled HA 110/SGSN 114 may be introduced in a single PLMN 108 initially, and may be phased in to other PLMNs 108, at a later time. The exemplary embodiment of the present invention may place control in the hands of an operator of the GPRS PLMN 108, i.e., there may be no dependence on an external internet service provider (ISP) to deploy a HA 110.

The exemplary embodiment of the present invention may consequently be used where a cellular operator that may provide the service may control all entities that may make the service access possible. In the absence of the exemplary embodiment of the present invention, the cellular operator may need to negotiate a multitude of agreements with various ISPs and/or may deploy multiple interworking entities in different hotspots 104 to enable similar functionality.

The exemplary embodiment of the present invention may allow the HA 110 to be active only when the Mobile Node 102 may access the GPRS network from a WLAN. The HA 110 also may not need to advertise. Thus an exemplary embodiment of the present invention may not be tied to deploying a HA 110 per subnet. Multiple subnetted operators may support service access without any external dependencies.

There may be few components in the network infrastructure to manage.

An exemplary embodiment of the present invention may work with IP networks (such as, e.g., but not limited to, IPv4 or IPv6, etc.) and/or with transition networks.

An exemplary embodiment of the present invention may be deployed on, e.g., but not limited to, an IXP blade with a micro-engine performance extension.

In another exemplary embodiment, an MN 102 may include a modified version of an operating system (OS), which may support multiple addresses per network interface card (NIC) and may allow services to be associated with the multiple supported addresses. The modified OS embodiment, may lead to fragmentation of OS platforms.

In another exemplary embodiment, the present invention may degrade gracefully including, e.g., in an event of breaking down of the HA 110 functionality, the present invention may allow normal GPRS traffic to flow unhindered.

An exemplary embodiment of the present invention may be scalable including, e.g., but not limited to, introducing one or more entities as may be deemed needed. The present invention may not further load an existing network device in the PLMN 108.

An exemplary embodiment of the present invention may include flexibility and may be implemented in a collocated or non-collocated manner.

In an exemplary embodiment of the present invention, multiple WLANs and/or roaming between multiple IP based networks may be supported by a single instantiation of the present invention.

Although in the exemplary embodiment a user 101 (not shown) may be described as using a device referred to as a client or MN 102 that may be coupled to a device referred to as a server device, the client 102 and server devices 110, 120 need not have a client/server relationship. For example, client 102 and the server devices may be similar devices and/or may communicate in a peer-to-peer manner. Alternatively, client device 102 and the server device may be labeled first device 102 and second device, respectively. Further the devices 102, 110, 120 as described may be coupled via one or more communications links, such as, e.g., but not limited to wireless communications links. Other ways of coupling client 102 and the server may equally be used to accomplish communication such as, e.g., (but not limited to) a wired network connection, a local connection, a local area, wide area, or metropolitan area network connection, a community access television (CATV, or cable TV) connection, a satellite connection, a bus connection, an optical connection, a parallel or serial data bus, universal serial bus (USB) connection, or other bus, etc.

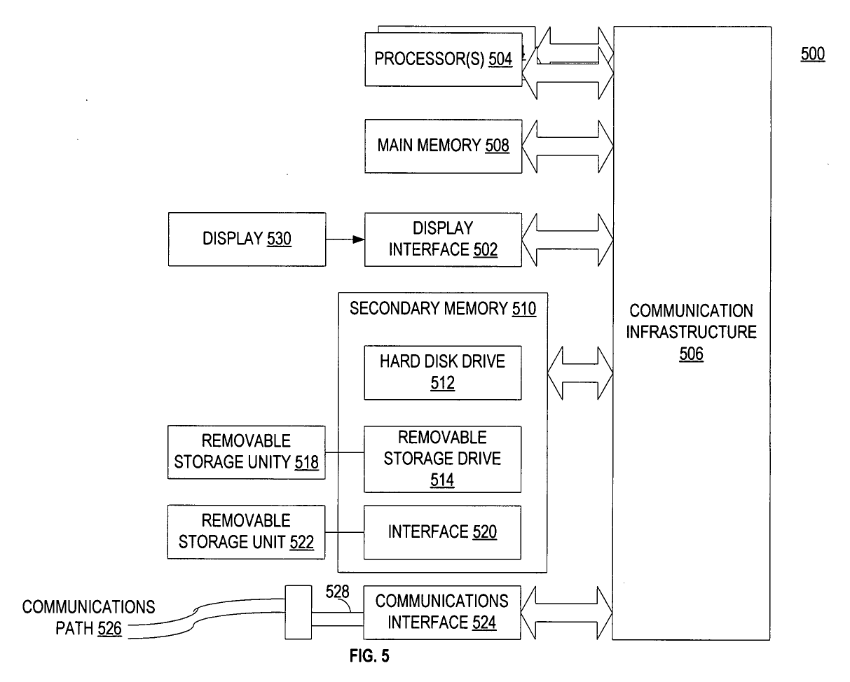

FIG. 5 depicts an exemplary embodiment of a computer system that may be used in computing devices such as, e.g., but not limited to, client or server devices according to an exemplary embodiment of the present invention. FIG. 5 depicts an exemplary embodiment of a computer system that may be used as client device 102, or a server device 104, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 500 is shown in FIG. 5, depicting an exemplary embodiment of a block diagram of an exemplary computer system useful for implementing the present invention. Specifically, FIG. 5 illustrates an example computer 500, which in an exemplary embodiment may be, e.g., (but not limited to) a personal computer (PC) system running an operating system such as, e.g., (but not limited to) WINDOWS MOBILE ™ for POCKET PC, or MICROSOFT® WINDOWS® NT/98/2000/XP/CE/,etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., U.S.A.) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 500 is shown in FIG. 5. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 5.

The computer system 500 may include one or more processors, such as, e.g., but not limited to, processor(s) 504. The processor(s) 504 may be connected to a communication infrastructure 506 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 500 may include a display interface 502 that may forward, e.g., but not limited to, graphics, text, and other data, etc., from the communication infrastructure 506 (or from a frame buffer, etc., not shown) for display on the display unit 530.

The computer system 500 may also include, e.g., but may not be limited to, a main memory 508, random access memory (RAM), and a secondary memory 510, etc. The secondary memory 510 may include, for example, (but not limited to) a hard disk drive 512 and/or a removable storage drive 514, representing a floppy diskette drive, a magnetic tape drive, an optical disk drive, a compact disk drive CD-ROM, etc. The removable storage drive 514 may, e.g., but not limited to, read from and/or write to a removable storage unit 518 in a well known manner. Removable storage unit 518, also called a program storage device or a computer program product, may represent, e.g., but not limited to, a floppy disk, magnetic tape, optical disk, compact disk, etc. which may be read from and written to by removable storage drive 514. As will be appreciated, the removable storage unit 518 may include a computer usable storage medium having stored therein computer software and/or data.

In alternative exemplary embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 522 and interfaces 520, which may allow software and data to be transferred from the removable storage unit 522 to computer system 500.

Computer 500 may also include an input device such as, e.g., (but not limited to) a mouse or other pointing device such as a digitizer, and a keyboard or other data entry device (none of which are labeled).

Computer 500 may also include output devices, such as, e.g., (but not limited to) display 530, and display interface 502. Computer 500 may include input/output (I/O) devices such as, e.g., (but not limited to) communications interface 524, cable 528 and communications path 526, etc. These devices may include, e.g., but not limited to, a network interface card, and modems (neither are labeled). Communications interface 524 may allow software and data to be transferred between computer system 500 and external devices. Examples of communications interface 524 may include, e.g., but may not be limited to, a modem, a network interface (such as, e.g., an Ethernet card), a communications port, a Personal Computer Memory Card International Association (PCMCIA) slot and card, etc. Software and data transferred via communications interface 524 may be in the form of signals 528 which may be electronic, electromagnetic, optical or other signals capable of being received by communications interface 524. These signals 528 may be provided to communications interface 524 via, e.g., but not limited to, a communications path 526 (e.g., but not limited to, a channel). This channel 526 may carry signals 528, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 514, a hard disk installed in hard disk drive 512, and signals 528, etc. These computer program products may provide software to computer system 500. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,”or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 508 and/or the secondary memory 510 and/or removable storage units 514, also called computer program products. Such computer programs, when executed, may enable the computer system 500 to perform the features of the present invention as discussed herein. In particular, the computer programs, when executed, may enable the processor 504 to provide a method to resolve conflicts during data synchronization according to an exemplary embodiment of the present invention. Accordingly, such computer programs may represent controllers of the computer system 500.

In another exemplary embodiment, the invention may be directed to a computer program product comprising a computer readable medium having control logic (computer software) stored therein. The control logic, when executed by the processor 504, may cause the processor 504 to perform the functions of the invention as described herein. In another exemplary embodiment where the invention may be implemented using software, the software may be stored in a computer program product and loaded into computer system 500 using, e.g., but not limited to, removable storage drive 514, hard drive 512 or communications interface 524, etc. The control logic (software), when executed by the processor 504, may cause the processor 504 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11, such as those referenced above, etc.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method, comprising:
receiving from a mobile IP (MIP) client an internet protocol (IP) packet associated with one or more packet data protocol (PDP) contexts for the MIP client at a home agent (HA);
maintaining a binding table at said HA including the one or more PDP context IP addresses associated with a home address of the MIP client;
replacing a source IP address of the IP packet with an appropriate one of said PDP context IP addresses based on a destination IP address of the IP packet;
forwarding the IP packet to a 3G server;
receiving at said HA an inbound IP packet from the 3G server destined for the MIP client;
replacing a destination IP address of the inbound IP packet with the home address of the MIP client; and
forwarding the inbound IP packet to the MIP client.

2. The method of claim 1, wherein said maintaining said binding table comprises
maintaining said PDP context IP addresses at said HA associated with the home address of the MIP client, wherein said PDP context IP address is associated with a gateway GPRS service node (GGSN) as a result of one or more PDP context activations.

3. The method of claim 1, further comprising receiving a registration request (RRQE) at said HA, said RRQE further comprising:
receiving a PDP-context activation/deactivation request and a service request identifier (SRI) at said HA;
updating said binding table of said HA with the received PDP context IP address, and
sending a registration reply (RRP) comprising a PDP context activation/deactivation reply, said SRI, and a success/failure status.

4. The method of claim 1, wherein said forwarding the IP packet comprises
forwarding the IP packet to a service GPRS service node (SGSN) for forwarding on to said 3G server.

5. The method of claim 1, wherein said receiving the IP packet from the MIP-enabled client comprises:
receiving said IP packet from the MIP client, wherein the MIP client is roaming via a wireless local area network (WLAN).

6. The method of claim 1, further comprising:
translating between IPv4 and IPv6 IP addresses.

7. A method, comprising:
sending an internet protocol (IP) packet destined for a 3G server from a mobile IP (MIP) client to a home agent (HA), the HA maintaining a binding table including one or more packet data protocol (PDP) context IP addresses associated with a home address of said MIP client, the HA replacing a source IP address of the IP packet with an appropriate one of said PDP context IP addresses based on a destination IP address of the IP packet, the HA forwarding the IP packet to the 3G server; and
receiving an inbound IP packet at said MIP client from the HA, the HA having received the inbound IP packet from the 3G server destined for said MIP client, and the HA having replaced a destination IP address of the inbound IP packet with the home address of said MIP client.

8. The method of claim 7, wherein said sending comprises:
sending the IP packet to the HA, wherein the HA is maintaining the PDP context IP addresses associated with the home address of said MIP client, wherein the PDP context IP address is associated with a gateway GPRS service node (GGSN) as a result of one or more PDP context activations.

9. The method of claim 7, further comprising sending a registration request (RRQE) to the HA, said RRQE further comprising:
sending a PDP-context activation/deactivation request and a service request identifier (SRI) to the HA; and
receiving a registration reply (RRP) comprising a PDP context activation/deactivation reply, said SRI, and a success/failure status from the HA, the HA having updated the binding table of the HA with the sent PDP context IP address.

10. The method of claim 7, wherein said sending comprises:
sending the IP packet to the HA, wherein the HA is forwarding the IP packet to a service GPRS service node (SGSN) for forwarding on to the 3G server.

11. The method of claim 7, wherein said receiving comprises:
receiving the inbound IP packet at the MIP client from the HA while roaming via a wireless local area network (WLAN).

12. The method of claim 7, further comprising:
translating between IPv4 and IPv6 IP addresses.

13. A system, comprising:
a home agent (HA) adapted to be coupled to a mobile internet protocol (MIP) client, said HA adapted to receive from the MIP client an internet protocol (IP) packet associated with one or more packet data protocol (PDP) contexts for the MIP client, to maintain a binding table including the one or more PDP context IP addresses associated with a home address of the MIP client, to replace a source IP address of the IP packet with an appropriate one of the PDP context IP addresses based on a destination IP address of the IP packet, to forward the IP packet to a 3G server, to receive an inbound IP packet from the 3G server destined for the MIP client, to replace a destination IP address of the inbound IP packet with the home address of the MIP client, and to forward the inbound IP packet to the MIP client.

14. The system of claim 13, wherein said HA is adapted to be coupled to a service GPRS service node (SGSN).

15. The system of claim 13, wherein said HA is adapted to be coupled to the MIP client by a wireless communications network.

16. The system of claim 15, wherein said wireless communications network comprises a wireless local area network (WLAN).

17. A system comprising:
a mobile internet protocol (MIP) client adapted to be coupled with a home agent (HA), said MIP client adapted to send an IP packet destined for a 3G server from said MIP client to the HA, the HA adapted to maintain a binding table including one or more packet data protocol (PDP) context IP addresses associated with a home address of said MIP client, the HA adapted to replace a source IP address of the IP packet with an appropriate one of said PDP context IP addresses based on a destination IP address of the IP packet, and the HA adapted to forward the IP packet to the 3G server; and said MIP client further adapted to receive an inbound IP packet at said MIP client from the HA, the HA adapted to receive the inbound IP packet from the 3G server destined for said MIP client, and the HA adapted to replace a destination IP address of the inbound IP packet with said home address of said MIP client.

18. The system of claim 17, wherein said MIP client is adapted to send the IP packet to the HA, wherein the HA is adapted to maintain the PDP context IP addresses assigned to said MIP client, wherein the PDP context IP address was assigned to said MIP client by a gateway GPRS service node (GGSN) as a result of one or more PDP context activations.

19. The system of claim 17, wherein said MIP client is adapted to send the IP packet to the HA, wherein the HA is adapted to forward the IP packet to a service GPRS service node (SGSN) for forwarding on to the 3G server.

20. The system of claim 17, wherein said MIP client is adapted to receive the another IP packet at the MIP client from the HA while roaming via a wireless local area network (WLAN).

21. The system of claim 17, wherein said MIP client is adapted to be coupled to the HA via a WLAN access point (AP) coupled to the HA.

22. The system of claim 17, wherein said MIP client is adapted to be coupled to the HA via a wireless communications network.

23. A machine-readable medium that provides instructions, which when executed by a computing platform, cause said computing platform to perform operations comprising a method comprising:
receiving from a mobile IP (MIP) client an internet protocol (IP) packet associated with one or more packet data protocol (PDP) contexts for the MIP client at a home agent (HA);
maintaining a binding table at said HA including the one or more PDP context IP addresses associated with a home address of the MIP client;
replacing a source IP address of the IP packet with an appropriate one of said PDP context IP addresses based on a destination IP address of the IP packet;
forwarding the IP packet to a 3G server;
receiving at said HA an inbound IP packet from the 3G server destined for the MIP client;
replacing a destination IP address of the inbound IP packet with the home address of the MIP client; and
forwarding the inbound IP packet to the MIP client.

24. The machine-readable medium of claim 23, wherein said maintaining said binding table comprises:
maintaining said PDP context IP addresses at said HA associated with the home address of the MIP client, wherein said PDP context IP address is associated with a gateway GPRS service node (GGSN) as a result of one or more PDP context activations.

25. The machine readable medium of claim 23, wherein the method further comprises receiving a registration request (RRQE) at said HA.

26. The machine readable medium of claim 25, wherein the method further comprises:
receiving a PDP-context activation/deactivation request and a service request identifier (SRI) at said HA;
updating said binding table of said HA with the received PDP context IP address, and
sending a registration reply (RRP) comprising a PDP context activation/deactivation reply, said SRI, and a success/failure status.

27. The machine-readable medium of claim 23, wherein said forwarding the IP packet comprises:
forwarding the IP packet to a service GPRS service node (SGSN) for forwarding on to said 3G server.

28. The machine-readable medium of claim 23, wherein said receiving the IP packet from the MIP client comprises:
receiving said IP packet from the MIP client, wherein the MIP client is roaming via a wireless local area network (WLAN).

29. A machine-readable medium that provides instructions, which when executed by a computing platform, cause said computing platform to perform operations comprising a method of:
sending an internet protocol (IP) packet destined for a 3G server from a mobile IP (MIP) client to a home agent (HA), the HA maintaining a binding table including one or more packet data protocol (PDP) context IP addresses associated with a home address of said MIP client, the HA replacing a source IP address of the IP packet with an appropriate one of said PDP context IP addresses based on a destination IP address of the IP packet, the HA forwarding the IP packet to the 3G server; and
receiving an inbound IP packet at said MIP client from the HA, the HA having received the inbound IP packet from the 3G server destined for said MIP client, and the HA having replaced a destination IP address of the inbound IP packet with the home address of said MIP client.

30. The machine-readable medium of claim 29, wherein said sending comprises:
sending the IP packet to the HA, wherein the HA is maintaining the PDP context IP addresses associated with the home address of said MIP client, wherein the PDP context IP address is associated with a gateway GPRS service node (GGSN) as a result of one or more PDP context activations.

31. The machine readable medium claim 29, wherein the method further comprises sending a registration request (RRQE) to the HA.

32. The machine readable medium of claim 31, wherein the method further comprises:
sending a PDP-context activation/deactivation request and a service request identifier (SRI) to the HA; and
receiving a registration reply (RRP) comprising a PDP context activation/deactivation reply, said SRI, and a success/failure status from the HA, the HA having updated the binding table of the HA with the sent PDP context IP address.

33. The machine-readable medium of claim 29, wherein said sending comprises:
sending the IP packet to the HA, wherein the HA is forwarding the IP packet to a service GPRS service node (SGSN) for forwarding on to the 3G server.

34. The method machine-readable medium of claim 29, wherein said receiving comprises:
receiving the another IP packet at the MIP client from the HA while roaming via a wireless local area network (WLAN).
